(19) United States
(12) Patent Application Publication
(10) Pub. No.: US 2018/0043600 A1
(43) Pub. Date: Feb. 15, 2018

(54) EXTRUDER DIE PLATE FOR REDUCED STRAND SURGING

(71) Applicant: SABIC Global Technologies B.V., Bergen op Zoom (NL)

(72) Inventor: Hochul JUNG, Perry, OH (US)

(21) Appl. No.: 15/528,271

(22) PCT Filed: Nov. 23, 2015
(86) PCT No.: PCT/US15/62132

§ 371 Date: May 19, 2017

Related U.S. Application Data
(60) Provisional application No. 62/085,596, filed on Nov. 30, 2014.

(51) Int. Cl. B29C 47/30; B29C 47/00; B29C 47/08; B29C 47/80; B29C 47/92

(52) U.S. Cl. CPC B29C 47/30; B29C 47/802; B29C 47/92; B29C 47/0801; B29C 47/0004

(57) ABSTRACT

The present disclosure relates to an extrusion system including a die plate configuration to reduce inconsistent flow of an extruded product and the accompanying distortions of the extruded product.

### RELATED APPLICATIONS

This application claims benefit to U.S. Patent Application No. 62/085,596, filed on Nov. 30, 2014, the disclosure of which is incorporated herein in its entirety for any and all purposes.

### TECHNICAL FIELD

The disclosure relates generally to extrusion and more particularly to an extrusion system and method for reducing strand surging.

### BACKGROUND

Polymeric materials and resins may undergo the process of extrusion in the production of finished articles for consumer and industrial applications. In a given extruder, a material proceeds through the body of the extruder and is directed through a number of dies to form the desired extrusion output. Often, the extrusion process may comprise one of many components of the entire production line. Thus, the extruder must operate in the desired manner (e.g., desired temperature and speed) to yield the desired product. Nevertheless, unfavorable results may occur in the extruder output. Strand surging represents a kind unfavorable distortion in the extrusion output of thermoplastic materials. Surging can refer to the duration per unit time of output variations where the material exiting the extruder is inconsistent or irregular. These fluctuations in extruder output often manifest as distortions and dimensional variations in the extrusion output product, resulting in a diminished yield. The distortion may be highlighted in polymeric materials where the surging is a product of altered polymer viscosity or excess polymer shear.

### SUMMARY

The extrusion of thermoplastic materials may suffer from strand surging leading to undesirable distortions in the extrusion output. Highly filled thermoplastic materials are susceptible to surging because of their high viscosity. The high viscosity contributes to excessive shear, causing flow instability and ultimately resulting in surging. With respect to the equipment of an extrusion system, surging can be attributed to a poorly controlled system temperature, which can generate excess polymer shear. Surging can further be attributed to a worn extrusion screw or barrel, which can cause non-uniform polymer shear. An inconsistent motor speed, which can contribute to an irregular polymer shear, can also cause surging. Wide fluctuations in extrusion system temperatures, which affects heating shear, also contribute to surging. Overall poor die design can directly affect polymer flow uniformity through the die and can generate surged strands in the extruder output. Accordingly, there remains a need for an extrusion system configured to combat strand surging of the extrusion output, especially for filled thermoplastics.

In one aspect, the disclosure relates to an extrusion system as further described in detail herein. The extrusion system can comprise an extrusion channel configured to pass a material along a longitudinal axis. The extrusion channel can have an inlet port and an outlet port in material communication therewith. A mechanism can be disposed within the extrusion channel to cause the material to move along the longitudinal axis from the inlet port to the outlet port. As an example, the mechanism can comprise at least a screw oriented along the longitudinal axis of the extrusion channel. A heating element can be configured to deliver thermal energy to the extrusion channel to heat the material passing through the extrusion channel. A die plate can be disposed adjacent the outlet port of the extrusion channel to at least partially enclose the outlet port. The die plate can comprise a plurality of orifices wherein the ratio of depth of each of the orifices to diameter of each of the orifices is from about 3:1 to about 4:1.

While aspects of the present disclosure can be described and claimed in a particular statutory class, such as the system statutory class, this is for convenience only and one of skill in the art will understand that each aspect of the present disclosure can be described and claimed in any statutory class.

### BRIEF DESCRIPTION OF THE DRAWINGS

The accompanying figures, which are incorporated in and constitute a part of this specification, illustrate several aspects and together with the description serve to explain certain aspects of the disclosure.

FIG. 1 shows an example extrusion system according to an aspect of the present disclosure.

FIG. 2A shows a side-view schematic of an example die plate according to an aspect of the present disclosure.

FIG. 2B shows a bottom-view schematic of an example die plate according to an aspect of the present disclosure.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

In the extrusion of polymeric materials, strand surging can result in undesirable distortions in the extruded product. Surging can be attributed to a number of components in an extrusion system. For example, the configuration of the die can directly affect polymer flow uniformity. This inconsistent flow can manifest as distortions in the extrusion output. Surging distortion can also be evident as poorly formed extrusion pellets and an overall low yield of extrusion product. The present disclosure can be understood more readily by reference to the following detailed description and the Examples included therein. In various aspects, the present disclosure pertains to an extrusion system including a die plate configuration which can reduce strange surging of the extruder output. The configuration of the plate, including the size and dimension, or geometry, of the plate orifices and the composition of the plate itself, can affect the uniformity of the flow of the extruded material. With respect to plate geometry, a ratio of the length of the orifice (L) to the diameter of the orifice (D) herein referred to L/D can be manipulated to influence flow uniformity. As an example, L/D can be increased to stabilize flow. However, an increase in L/D may be accompanied by an increase in temperature. This temperature increase can degrade the extrusion material, particularly where the extrusion material is a highly filled thermoplastic compound. Accordingly, the disclosed configuration of the extrusion system and its plate can minimize the duration of the imbalanced or unstable flow, herein described as surging, while avoiding potentially damaging system temperatures.

In an aspect, the extrusion system can comprise an extruder housing which defines an extrusion channel through which a material can pass. The extrusion channel can include a longitudinal axis which can also have an inlet port and an outlet port. A material for extrusion can be introduced to the extrusion system through a material feeding component which can direct the material into the adjacent inlet port. The extruder housing can also contain a mechanism which can cause the material to move along the longitudinal axis of the extrusion channel from the inlet port to the outlet port of the extruder housing. The mechanism can comprise at least a screw which is oriented along the longitudinal axis of the extrusion channel. The screw can be driven or operated by the mechanism to convey the material through the extruder housing. A heating element can be used within the extruder housing to deliver thermal energy to the extrusion channel and heat the material passing through the extruder housing. To monitor the temperature of the material moving through the extruder housing, a measurement instrument can be configured to the extruder housing. In various aspects, a plate can be disposed adjacent the outlet port of the extruder housing. The plate can be disposed so that it does not completely obstruct the outlet port. The plate can at least partially enclose the outlet port allowing the material for extrusion to pass through a series of orifices within the plate. Indeed, the plate can comprise a plurality of orifices through which the material can pass, wherein the ratio of the depth of the orifices to the diameter of the orifices is approximately 3:1. Furthermore, a layer of nitride can be deposited on the surface of the plate proximal to the outlet port, that is, towards the outlet port.

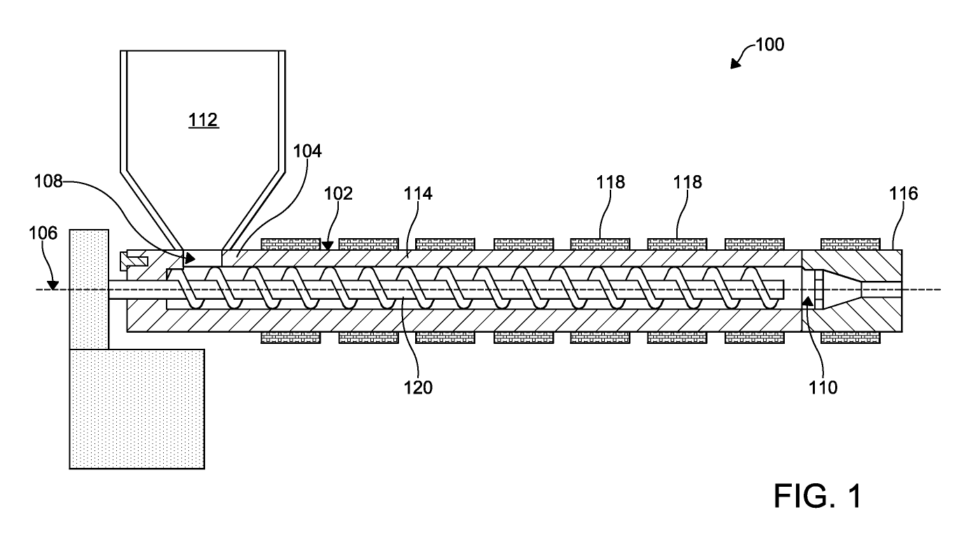

In an aspect, FIG. 1 presents an extrusion system 100. The extrusion system 100 can comprise an extruder housing 102 which can define an extrusion channel 104 therein. The extrusion channel 104 can have a longitudinal axis 106 along which a material introduced into the extrusion system 100 can pass. The extruder housing 102 can be configured to receive a material and to convey the material therethrough. The extrusion system 100 can extrude a material, such as a thermoplastic or a highly filled thermoplastic, which can be in particulate form or in a molten form. The extruder housing 102 can be configured to pass the material therethrough at a prescribed rate of extrusion and according to a desired temperature profile. As an example, for thermoplastics, operation at the prescribed rate and temperature are necessary to combat variations in polymer shear which can contribute to surging at the extrusion output.

The extruder housing 102 can further comprise an inlet port 108 and an outlet port 110 for the introduction and discharge, respectively, of a material conveyed through the extruder housing 102. The inlet port 108 can receive the material from a material feeding component 112 (e.g., hopper) which serves as the holder for the incoming material. In an example, the material feeding component 112 can be oriented to feed the material for extrusion into the inlet port 108. This material feeding component 112 can be a vessel, a repository, or any suitable container aligned with the extrusion system 100 to supply the material for introduction into the inlet port 108.

The extruder housing 102 can also comprise a mechanism 114 to advance the extrusion material through the extrusion system 100. The mechanism 114 can be disposed within the extruder housing 102 to cause the material to travel along the longitudinal axis 106 of the extruder housing 102. The mechanism 114 can convey the material from the inlet port 108 to the outlet port 110 where the material is expelled through a die plate 116 containing a plurality of openings, or orifices of specific size and dimension. In various examples, the mechanism 114 can operate a screw extruder. The screw can be oriented along the longitudinal axis 106 of the extrusion channel 104 and can be caused to rotate. The motion of the screw can convey the material to the exit at the outlet port 110 and through the die plate orifices. At the exit, the manipulation of the configuration of the die plate 116 can affect surging time of the extrusion system 100 and overall quality of the extrusion product.

With respect to other considerations for achieving a desired extrusion product, a typical extrusion system 100 must also operate across a range of temperatures according to the material passing therethrough. In the extrusion of thermoplastics, the extrusion system 100 should heat the thermoplastic material at a uniform shear heating with minimal temperature fluctuations to achieve the desired product. The extrusion system 100 can be configured to extrude a material at certain temperatures or according to a particular rate. To ensure appropriate heating of the material, at least a heating element 118 can be included as a component of the extrusion system 100. In FIG. 1, the heating element 118 can be used to heat the extrusion channel 104 through which the extrusion material passes and thereby heat the material by converting electrical current to heat. The heat delivered to the material can be monitored in order to maintain the appropriate temperature profile for the extruded material. This can ensure that the material for extrusion receives a constant, even heat flow. In an example, the extruder housing 102 can include a measurement instrument 120 for measuring the temperature of the material as it is moved through the extruder housing 102. The measurement instrument 120 can incorporate at least one sensor which is in direct contact with the material as it travels through the extruder housing 102. In an example, the measurement instrument 120 used to monitor the temperature of the material can be a thermocouple. Furthermore, in various examples, the mechanism 114 conveying the material through the extruder housing 102 can operate at a prescribed speed to produce the extruded material at a desired rate. The mechanism 114 can receive feedback from the measurement instrument 120 to control the rate of operation of the screw and ultimately the rate of extrusion.

In various aspects, the configuration of the die plate 116 can govern the shape of the extruder output as well as influence the occurrence of surging in the extrusion system 100. More specifically, an uneven flow of the material through the extrusion system 100 at the orifices can be minimized according to orifice size and dimension. As noted, the extruder housing 102 can also include a plate positioned at the outlet port to shape and form the material for extrusion through a series of openings, or orifices. In an example, the die plate 116 can be disposed adjacent the outlet port 110 of the extruder housing 102 to at least partially enclose the outlet port 110. The orifices of the die plate 116 can allow for the travelling extrusion material to pass through the die plate 116. The material for extrusion can thus adopt the size and shape of the die plate orifices. In an aspect, the dimension and size of the orifices can be fashioned so as to minimize surging of the extruder material as it exits the extrusion system 100.

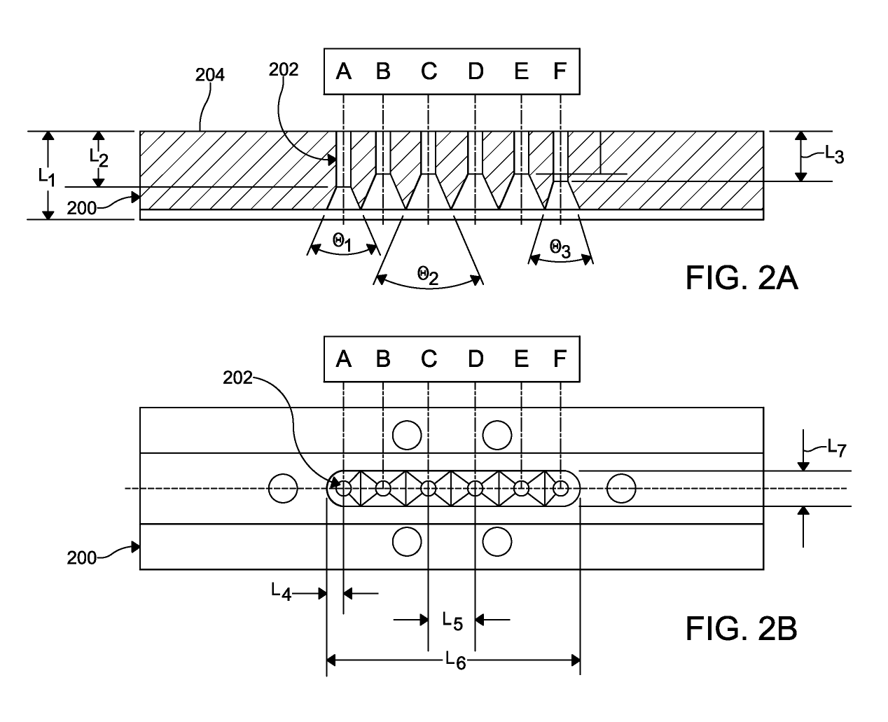

In various aspects, the die plate 116 can comprise a plurality of orifices through which the material for extrusion can pass. FIGS. 2A-2B present an aspect of a die plate 200 that can be used as the die plate 116 (FIG. 1). Other configurations can be used. As shown in FIGS. 2A-2B, the die plate 200 can comprise a plurality of apertures or orifices 202. Indeed, the number of orifices can be increased or decreased according to the throughput rate or according to the preference of the extrusion system operator. For example, the plate can comprise at least one orifice. In some embodiments, the plate can comprise from at least one orifice to about one hundred orifices. In a further example, the die plate 200 can comprise six orifices 202 (labeled A-F in FIGS. 2A-2B for distinction). These orifices 202 can have specific dimensions configured to minimize the duration of surging as the material passes through. For example, the ratio of the depth (parallel to the flow of material) of the orifices 202 to the diameter (orthogonal to the depth measurement) of the orifices 202 can be about 3:1 or between about 3:1 and about 4:1. In further examples, the orifices 202 can be of uniform size, or in the alternative, the orifices 202 can be of varying sizes. The orifices 202 can be sized so that orifices 202 situated adjacent the periphery of the die plate 200 have a larger diameter than the orifices 202 situated towards the interior of the die plate 200. In an example, the diameter of the orifices 202 can be about 0.155 inches (in.). In yet another example, the diameter of the orifices can be about 0.160 in. Other diameters can be used.

As a non-limiting an illustrative example only, the die plate 200 has the following dimensions: L₁=0.983 in.; L₂=0.620 in.; L₃=0.542 in.; L₄=0.188 in; L₅=0.532 in.; L₆=2.87 in.; L₇=0.375 in.; however, other dimensions may be used. For example, orifices labeled as B, C, D, and E may have a length (e.g., 0.465 in.) that is less than the length of the orifices A and F. The orifices 202 of the die plate 20 may have a angled portion with dimensions: θ₁=45°; θ₂=49°; and θ₃=35°. As an example, orifices B, C, D, and E have an angle θ₂. However, other configurations may be used.

Surging of the extruder system can also be influenced by the substance comprising the die plate 200. The composition of the die plate 200 can affect surging through the orifices 202 according to the friction generated between the material for extrusion (typically a polymer) and the surface of the die plate 200. The friction generated between the material and the surface of the die plate 200 can depend upon the friction coefficient of the substance comprising the die plate 200. In an aspect, the die plate 200 can comprise a metal. The friction generated can further depend on the crystal structure of the metal comprising the die plate. For metals having a cubic close-packed crystal structure and for some metals having a body-centered cubic crystal structure, such as iron and molybdenum, the friction coefficient can increase at higher temperatures. Metals having a cubic close packed structure include nickel, copper, gold, and silver, as well as the alloys steel and stainless steel. The coefficient of friction of steel and stainless steel begins to increase at about 200° C. and can reach a maximum value at about 300° C. In many aspects, the die plate 200 through which the heated material passes can be formed from or comprise steel. For example, the die plate 200 can comprise 4140 grade steel. In other aspects, a layer of material can be disposed adjacent the die plate 200 or coated on a surface of the die plate 200 abutting the outlet port 110 (FIG. 1) to alter the friction generated between the extrusion material and the die plate 200. The coefficient of friction of nitrided steel, that is, steel having a diffuse layer of nitrogen gas, tends to decrease at elevated temperatures. In an example, the layer of material disposed adjacent the die plate 200 can be or comprise a layer of nitride 204. Given that an extrusion system may necessarily operate at elevated temperatures as described herein, the layer of nitride 204 can reduce the coefficient of friction between a polymer material and surface of the die plate 200.

Thus, the die plate (e.g., die plate 116, 200) configuration of the extrusion system can alter the surging time of the extruder output by manipulating the material flow at the orifices 202. In an aspect, the configuration of the die plate 200 can result in less time of surging and distortion of the extruder output. The geometry of the orifices 202, as well as the composition of the die plate 200 itself, can be configured to minimize the duration of uneven flow through the orifices 202 and provide a more desirable extrusion product. In a further aspect, the configuration of a diameter of the orifices 202 combined with the ratio of the length of the orifices 202 to the diameter of the orifices can be manipulated to produce a reduced surging system.

It is to be understood that unless otherwise expressly stated, it is not intended that methods set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is not intended that an order be inferred.

### Methods

In an aspect, and by means of example rather than limitation, the extrusion system can operate as follows. A material (including any appropriate thermoplastic resin) can be introduced to a material feed component which can be a vessel, container, or a similarly bound reservoir. The material can enter the material feed component which is disposed adjacent an extruder housing for an extrusion channel. The extrusion channel can have a longitudinal axis along which an inlet port and an outlet port are situated. The extruder housing can deliver thermal energy to the extrusion channel to heat the material for extrusion as it passes through the system. As the material travels the length of the extruder housing, a temperature measurement instrument coupled to the extrusion system can assess the temperature of the material at a various positions.

A mechanism disposed along the longitudinal axis can be engaged, thereby directing the material from the material feed component to the inlet port of the extrusion channel. This mechanism can comprise a screw which rotates to advance the material through the extruder housing. The motion of the screw can direct the material from the inlet port to the engaged mechanism and convey the material downstream along the longitudinal axis and to the outlet port. Finally, at the outlet port, the extrusion material can pass through a barrier which can have several openings, or orifices. The barrier can be configured to alter the flow of extruded material and the amount of friction generated between the barrier and the passing extruded material. These barrier orifices can be of a particular size and dimension. The ratio of the depth of the orifices to the diameter of the orifices can be about 3:1 or from about 3:1 to about 4:1. The plate can further comprise a layer of nitride towards the outlet port and in contact with the extrusion material as the material passes through the orifices of the barrier.

The disclosed compositions and methods include at least the following aspects.

Aspect 1. An extrusion system comprising: an extrusion channel configured to pass a material along a longitudinal axis, the extrusion channel having an inlet port and an outlet port in material communication therewith; a mechanism disposed within the extrusion channel to cause the material to move along the longitudinal axis from the inlet port to the outlet port, the mechanism comprising at least a screw oriented along the longitudinal axis of the extrusion channel; a heating element configured to deliver thermal energy to the extrusion channel to heat the material passing through the extrusion channel; and a die plate disposed adjacent the outlet port of the extrusion channel to at least partially enclose the outlet port, wherein the die plate comprises a plurality of orifices, and wherein a ratio of depth of each of the orifices to diameter of each of the orifices is from about 3:1 to about 4:1.

Aspect 2. The extrusion system of aspect 1, wherein a nitride layer is disposed adjacent the die plate and proximal to the outlet port.

Aspect 3. The extrusion system of any one of aspects 1-2, wherein the material is a thermoplastic.

Aspect 4. The extrusion system of any one of aspects 1-3, wherein the material is a highly filled thermoplastic.

Aspect 5. The extrusion system of any one of aspects 1-4, wherein the material is a particulate or molten form.

Aspect 6. The extrusion system of aspect 1, further comprising a measurement instrument configured to measure a characteristic of the material within the extrusion channel.

Aspect 7. The extrusion system of aspect 6, wherein the measurement instrument comprises a thermocouple.

Aspect 8. The extrusion system of any one of aspects 1-7, wherein the die plate is formed from steel.

Aspect 9. The extrusion system of any one of aspects 1-8, wherein the die plate comprises six orifices.

Aspect 10. The extrusion system of any one of aspects 1-9, wherein each of the plurality of orifices have uniform diameter.

Aspect 11. The extrusion system of aspect 10, wherein the diameter of each orifice is about 0.160 inches.

Aspect 12. An extrusion die plate comprising a plurality of orifices wherein a ratio of depth of each of the orifices to diameter of each of the orifices is from about 3:1 to about 4:1.

Aspect 13. The extrusion die plate of aspect 12, wherein the extrusion die plate comprises a layer of nitride.

Aspect 14. The extrusion system of any one of aspects 1-11, wherein the material passes through the die plate with less time of surging per minute compared to a substantially similar die plate without the plurality of orifices having the ratio of depth of the orifices to diameter of the orifices from about 3:1 to about 4:1.

Aspect 15. A method comprising: introducing a material to an extrusion channel configured to pass a material along a longitudinal axis, the extrusion channel having an inlet port and an outlet port in material communication therewith; directing the material from the inlet port to the outlet port, while delivering thermal energy to the material in the extrusion channel; directing the material a die plate disposed adjacent the outlet port of the extrusion channel to at least partially enclose the outlet port, wherein the die plate comprises a plurality of orifices, and wherein a ratio of depth of each of the orifices to diameter of each of the orifices is from about 3:1 to about 4:1.

Aspect 16. The method of aspect 15, wherein a nitride layer is disposed adjacent the die plate and proximal to the outlet port.

Aspect 17. The method of any one of aspects 15-16, wherein the material is a thermoplastic.

Aspect 18. The method of any one of aspects 15-17, wherein the die plate is formed from steel.

Aspect 19. The method of any one of aspects 15-18, wherein the die plate comprises at least six orifices.

Aspect 20. The method of any one of aspects 15-19, wherein each of the plurality of orifices have uniform diameter.

Aspect 21. The method of any one of aspects 15-20, wherein the diameter of each orifice is about 0.160 inches.

Aspect 22. The method of any one of aspects 15-21, wherein the material passes through the die plate with less time of surging per minute compared to a substantially similar die plate without the plurality of orifices having the ratio of depth of the orifices to diameter of the orifices from about 3:1 to about 4:1.

### EXAMPLES

Detailed embodiments of the present disclosure are disclosed herein; it is to be understood that the disclosed embodiments are merely exemplary of the disclosure that may be embodied in various forms. Therefore, specific structural and functional details disclosed herein are not to be interpreted as limits, but merely as a basis for teaching one skilled in the art to employ the present disclosure. The specific examples below will enable the disclosure to be better understood. However, they are given merely by way of guidance and do not imply any limitation.

The following examples are put forth so as to provide those of ordinary skill in the art with a complete disclosure and description of how the methods, devices, and systems disclosed and claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for.

As a non-limiting example, sample dies were prepared according to the materials and dimensions presented in Table 1. A polyphenylene base resin was extruded with organic and inorganic fillers using a screw extruder (Werner-Pliederer ZSK super 40 mm) at a barrel temperature of 580° F. (304.4° C.), a feed rate of 250 lb/hr, and a screw speed of 270 RPM for five minutes to allow the extruder to stabilize. The extruder output was video recorded for three minutes, the video recording was stopped for two minutes, and then the recording continued for three more minutes. After visual observation of the stranding behavior for a given plate, the die plate was changed and the die was opened and thoroughly cleaned. The performance of the extrusion die plates was assessed according to the duration of strand surging (seconds per minute) observed at the orifices of the die plate.

Each die plate contained six openings, or orifices, labeled A to F according to its position from a first end of a plate to the opposite end when the plate was positioned in the extruder. Table 1 shows the die plate composition (whether steel, chrome coated steel, nitrided steel, or stainless steel), the diameter of each orifice A to F, and the orifice dimension ratio L/D where L refers to the length (or depth) of the orifice and D refers to the diameter of the orifice. Examples 1, 2, 3, and 4 (E1-E4) include orifices of substantially uniform size and dimension of about 0.155 in., but differ according to the composition of the plate. The following materials were used to form the die plate: Example 1 (E1) is 4140 steel; Example 2 (E2), chrome coated steel; Example 3 (E3), nitrided steel; and Example 4 (E4), stainless steel. Examples 5, 6, and 7 (E5-E7) are comprised of either steel or nitrided steel and have altered larger orifices at the peripheral orifices (e.g., orifices A and F where the diameter is about 0.160 in.) or altered L/D values at the peripheral orifices, or a combination of both. The L/D value for the die orifices A and F (peripheral orifices) of Example 5 (E5) are 3.5 and 4, respectively. For Example 6 (E6), the L/D values for all orifices remain constant at a value of 3. However, the diameter of the peripheral orifices A and F is increased to 0.160 in. while the diameter of each orifice B, C, D, and E is 0.155 in. Finally, Example 7 (E7) includes both altered peripheral orifices A and F diameters and L/D values. The L/D values of Orifices A and F are increased to 3.5 and 4.5 respectively, while the diameters are both increased to 0.160 in. Die plate E7 from the examples is also shown in FIGS. 2A-2B as die plate 200.

TABLE 1
Composition and dimensions associated with each die plate.

| | | Orifice Diameter (inches) | | | | | | L/D | | | | | |
|---|---|---|---|---|---|---|---|---|---|---|---|---|---|
| Die | | Orifice | | | | | | Orifice | | | | | |
| Plate | Metal type | A | B | C | D | E | F | A | B | C | D | E | F |
| E1 | 4140 steel | 0.155 | 0.155 | 0.155 | 0.155 | 0.155 | 0.155 | 3 | 3 | 3 | 3 | 3 | 3 |
| E2 | chrome coat | 0.155 | 0.155 | 0.155 | 0.155 | 0.155 | 0.155 | 3 | 3 | 3 | 3 | 3 | 3 |
| E3 | Nitrided | 0.155 | 0.155 | 0.155 | 0.155 | 0.155 | 0.155 | 3 | 3 | 3 | 3 | 3 | 3 |
| E4 | stainless steel | 0.155 | 0.155 | 0.155 | 0.155 | 0.155 | 0.155 | 3 | 3 | 3 | 3 | 3 | 3 |
| E5 | 4140 steel | 0.155 | 0.155 | 0.155 | 0.155 | 0.155 | 0.155 | 3.5 | 3 | 3 | 3 | 3 | 4 |
| E6 | 4140 steel | 0.160 | 0.155 | 0.155 | 0.155 | 0.155 | 0.160 | 3 | 3 | 3 | 3 | 3 | 3 |
| E7 | Nitrided | 0.160 | 0.155 | 0.155 | 0.155 | 0.155 | 0.160 | 3.5 | 3 | 3 | 3 | 3 | 4 |

### Illustrative Example 1

In illustrative Example 1, the surging times per minute of die plates E1 to E4 were observed. The surging times are presented in Table 2. Sample Examples E1 to E4 only differ according to the type of metal (E1—4140 steel, E2—chrome coated steel, E3—nitrided steel, and E4—stainless steel). All sample examples exhibited their highest respective surging times at peripheral orifice F. However, E3 comprising nitrided steel exhibits the lowest surging times overall and the lowest orifice F surging time. The results of Illustrative Example 1 indicated that nitrided steel and 4140 steel provide the lowest surging times (9.6 sec/min and 37.6 sec/min, respectively) of the steel die plates used.

TABLE 2
Surging time per minute for 4140 steel (E1), chrome coated steel (E2),
nitrided steel (E3), and stainless steel (E4).

| | Surging time (seconds/min) | | | | | | Total |
|---|---|---|---|---|---|---|---|
| | Orifice | | | | | | (sec/ |
| | A | B | C | D | E | F | min) |
| E1 | 4.1 | 6.9 | 3.5 | 2.2 | 3.0 | 17.9 | 37.6 |
| E2 | 8.1 | 12.5 | 7.0 | 9.6 | 16.6 | 35.8 | 89.6 |
| E3 | 0.0 | 0.5 | 0.0 | 0.0 | 0.0 | 9.1 | 9.6 |
| E4 | 2.9 | 4.2 | 2.1 | 3.5 | 14.9 | 30.7 | 58.3 |

### Illustrative Example 2

In illustrative Example 2, the influence of both plate composition and orifice geometry were observed for sample Examples E3, E5, E6, and E7. In illustrative Example 2, nitrided steel and 4140 steel plates were used because the surging values for these die plates were significantly lower than their chrome coated or stainless steel counterparts observed in illustrative Example 1. In the present illustrative Example 2, the die orifice diameter is increased about 6.6% from 0.155 in. to 0.160 in. for sample Examples E6 and E7. The flow rate for E6 and E7 were expected to increase by about 6.6% accordingly. Additionally, where an L/D ratio of 4 was used at orifice F, an L/D of 3.5 instead of 3 was used at Orifice A to combat the excessive surging at orifice F observed in illustrative Example 1.

Table 3 presents the die surging time (seconds surging per minute) for each die plate sample Examples E3, E5, E6, and E7. Results indicated that strand surging at the orifices of the 4140 plates is significantly reduced where the peripheral orifice diameters are increased to 0.160 in. Indeed, where the diameters of orifices A and F were increased to 0.160 in. and the L/D was maintained at 3, sample Example E6 exhibited the lowest total surging time (1.3 sec/min) of all plates observed.

Generally, the surging time per minute of the peripheral orifices A and F for each sample Example (E3, E5, E6, and E7) were significantly reduced compared to those values observed in illustrative Example 1. However for sample Example E5, a 4140 steel plate with enlarged peripheral orifices A and F (at 0.160 in.) as well as increased peripheral orifice L/D values, the surging times at orifices B and E are markedly higher (24.0 sec/min and 16.3 sec/min). Orifices B and E are the orifices adjacent to the increased diameter and L/D peripheral orifices A and F. For E5, die orifices with the larger L/D (orifices A and F) restricted the flow rate in the adjacent orifices having a smaller L/D (orifices B and E), significantly increasing the surging times. In comparison, although both the orifice diameter and L/D are increased in sample Example 7 (E7), E7 still showed a lower total surging time than E5 because of the nitrided surface of the plate (1.3 sec/min compared to 52.3 sec/min).

TABLE 3
Surging time for altered orifice geometry and plate composition.

| | Surging time (seconds/min) | | | | | | |
|---|---|---|---|---|---|---|---|
| Die | Orifice | | | | | | Total |
| Plate | A | B | C | D | E | F | (sec/min) |
| E3 | 0.0 | 1.0 | 0.8 | 0.5 | 1.9 | 4.4 | 8.6 |
| E5 | 0.0 | 16.3 | 6.2 | 5.8 | 24.0 | 0.0 | 52.3 |
| E6 | 0.0 | 0.0 | 0.0 | 0.0 | 0.0 | 1.3 | 1.3 |
| E7 | 0.0 | 0.8 | 0.0 | 0.0 | 0.0 | 2.3 | 3.1 |

It is noted that the surging times for die plate of sample Example E3 differ between illustrative Examples 1 and 2. Indeed, the surging time observed for E3's orifice F in illustrative Example 2 is higher (9.1 sec/min compared to 4.4 sec/min). This difference was attributed to room temperature and natural variation of the extruder system operation, such as speed.

A combined evaluation of illustrative Examples 1 and 2 showed that a change in the geometry of the die plate (E6) as well as a change in both the composition and geometry (E7) can reduce the surging time observed at extrusion die orifices. A combination of nitrided steel, with peripheral orifices having an increased diameter and an L/D ratio of 3 can significantly lower surging of the extrusion output.

Surging time was thus reduced by manipulating plate configuration with respect to the orifice size and the plate composition. The observed surging times suggest that increasing the die orifice diameter but not the L/D ratio at the peripheral orifices can significantly reduce strand surging time. Furthermore, the use of plates comprising a nitride layer can reduce surging time at the orifice compared to a dimensionally equivalent plate of 4140 steel.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

It is also to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “a polyamide polymer” includes mixtures of two or more polyamide polymers.

As used herein, the term “combination” is inclusive of blends, mixtures, alloys, reaction products, and the like.

As used herein, the term “substantially similar die plate” refers to a die plate that is substantially identical to the inventive die plate by consisting essentially of substantially the same composition, size, and dimension but differing by a single specified composition, size, or dimension or material. For example, a substantially similar die plate can have a plurality of orifices having the ratio of depth of the orifices to diameter of the orifices at a ratio other than from about 3:1 to about 4:1.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Certain abbreviations are defined as follows: “g” is grams, “in” or “in.” is inches, “kg” is kilograms, “° C.” is degrees Celsius, ° F. is degrees Fahrenheit, “lb/hr” is pound per hour, “RPM” is revolutions per minute, “min” is minutes, and “mm” is millimeter. Unless otherwise stated to the contrary herein, all test standards are the most recent standard in effect at the time of filing this application.

Each of the materials disclosed herein are either commercially available and/or the methods for the production thereof are known to those of skill in the art.

1. An extrusion system comprising:
an extrusion channel configured to move a material along a longitudinal axis, the extrusion channel having an inlet port and an outlet port in communication with the extrusion channel;
a mechanism disposed within the extrusion channel to cause the material to move along the longitudinal axis from the inlet port to the outlet port, the mechanism comprising at least a screw oriented along the longitudinal axis of the extrusion channel;
a heating element configured to deliver thermal energy to the extrusion channel to heat the material passing through the extrusion channel; and
a die plate disposed adjacent the outlet port of the extrusion channel to at least partially enclose the outlet port, wherein the die plate comprises a plurality of orifices, and wherein a ratio of depth of each of the orifices to diameter of each of the orifices is from about 3:1 to about 4:1.

2. The extrusion system of claim 1, wherein a nitride layer is disposed adjacent the die plate.

3. The extrusion system of claim 1, wherein the material is a thermoplastic.

4. The extrusion system of claim 1, wherein the material is a highly filled thermoplastic.

5. The extrusion system of claim 1, further comprising a measurement instrument configured to measure a characteristic of the material within the extrusion channel.

6. The extrusion system of claim 5, wherein the measurement instrument comprises a thermocouple.

7. The extrusion system of claim 1, wherein the die plate is formed from steel.

8. The extrusion system of claim 1, wherein the die plate comprises six orifices.

9. The extrusion system of claim 1, wherein each of the plurality of orifices have uniform diameter.

10. The extrusion system of claim 9, wherein the diameter of each orifice is about 0.160 inches.

11. The extrusion system of claim 1, wherein the material passes through the die plate with less surging per minute compared to a substantially similar die plate without the plurality of orifices having the ratio of depth of the orifices to diameter of the orifices from about 3:1 to about 4:1.

12. An extrusion die plate comprising a plurality of orifices wherein a ratio of depth of each of the orifices to diameter of each of the orifices is from about 3:1 to about 4:1.

13. The extrusion die plate of claim 13, wherein the extrusion die plate comprises a layer of nitride.

14. A method comprising:
introducing a material to an extrusion channel configured to pass a material along a longitudinal axis, the extrusion channel having an inlet port and an outlet port;
directing the material from the inlet port to the outlet port, while delivering thermal energy to the material in the extrusion channel;
directing the material through a die plate disposed adjacent the outlet port of the extrusion channel to at least partially enclose the outlet port, wherein the die plate comprises a plurality of orifices, and wherein a ratio of depth of each of the orifices to diameter of each of the orifices is from about 3:1 to about 4:1.

15. The method of claim 14, wherein a nitride layer is disposed adjacent the die plate and proximal to the outlet port.

16. The method of claim 14, wherein the material is a thermoplastic and the die plate comprises steel.

17. The method of claim 14, wherein the die plate comprises at least six orifices.

18. The method of claim 14, wherein each of the plurality of orifices have uniform diameter.

19. The method of claim 14, wherein the diameter of each orifice is about 0.160 inches.

20. The method of claim 14, wherein the material passes through the die plate with less time of surging per minute compared to a substantially similar die plate without the plurality of orifices having the ratio of depth of the orifices to diameter of the orifices from about 3:1 to about 4:1.
